(19) United States
(12) Patent Application Publication
(10) Pub. No.: US 2016/0125965 A1
(43) Pub. Date: May 5, 2016

(54) Power Plant

(71) Applicant: Hitachi-GE Nuclear Energy, Ltd., Hitachi-shi (JP)

(72) Inventors: Yamato MIKAMI, Hitachi (JP); Masayuki NAGASAWA, Hitachi (JP)

(21) Appl. No.: 14/925,260

(22) Filed: Oct. 28, 2015

(30) Foreign Application Priority Data
Oct. 29, 2014 (JP) 2014-220000

(51) Int. Cl. G21D 3/06; F28B 1/02; F28B 11/00; G01M 3/00

(52) U.S. Cl. CPC G21D 3/06; G01M 3/00; F28B 1/02; F28B 11/00

(57) ABSTRACT

A power plant includes a steam generator, a turbine driven by steam generated by the steam generator, a condenser which cools the steam discharged from the turbine to form condensate water by using seawater, a condensate water pipe which supplies the condensate water from the condenser to the steam generator, at least one seawater leak detection device which is included in the condensate water pipe and measures water quality of the condensate water to detect a leak of seawater in the condenser, an attemperator spray which connects to the condensate water pipe to be supplied with the condensate water from a connecting point where the attemperator spray connects to the condensate water pipe, and sprays the condensate water to the steam inside the condenser, and a pipe which diverges from the condensate water pipe and supplies the condensate water to the steam generator, wherein if the seawater leak detection device detects a leak of the seawater in the condenser, the power plant stops pouring the condensate water from the connecting point to the steam generator and stops pouring the condensate water to the pipe diverging from the condensate water pipe.

### CLAIM OF PRIORITY

The present application claims priority from Japanese Patent Application JP 2014-220000 filed on Oct. 29, 2014, the content of which is hereby incorporated by reference into this application.

### FIELD OF THE INVENTION

The present invention relates to a power plant.

### BACKGROUND OF THE INVENTION

In a power plant, a steam turbine is driven to generate electricity by steam generated from a steam generator (for example, a nuclear reactor for nuclear power generation or a boiler for thermal power generation), and the exhaust gas from the steam turbine is cooled and condensate in a condenser, thus forming condensate water. Generally, seawater is often used as cooling water for the condenser.

The condensate water is generally pressurized in stages by a condensate pump, a condensate booster pump and a feedwater pump. Also, the condensate water has impurities eliminated by a condensate filter device, and is demineralized by a condensate demineralization device, heated by a feedwater heater, and supplied to the steam generator.

In the case of a boiling water reactor, apart from the supply of condensate water to a nuclear reactor which is a steam generator, condensate water is supplied to a control rod drive system via a spillover line and this condensate water is ultimately fed into the nuclear reactor.

The cooling in the condenser is generally carried out by heat exchange due to the temperature difference between steam and seawater, by pumping up seawater with a circulating water system and supplying the seawater to a thin tube inside the condenser.

In such a power plant where steam is cooled by seawater, if the thin tube in the condenser is damaged and the seawater is leaked in the condenser, continued operation of the power plant causes the seawater to spread in the power plant and causes corrosion of plant component devices, pipes and the like. Particularly, in the case of a boiling water reactor plant, extensive restoration work is needed, including treatment of system water, and inspections and repairs of the devices and the like. Therefore, conventionally, if the operator finds out that the water quality (for example, conductivity) of the condensate water has changed, the operator assumes that there is a leak of seawater in the condenser, and manually prevents the seawater from spreading according operation procedures.

However, the manual operation by the operator cannot handle the leak of seawater if a large amount of seawater leaks, posing the risk that the seawater may spread in the power plant. As a technique of solving such a problem, JP 2001-32701, for example, discloses a power plant facility that detects a leak of seawater on the basis of the water quality of condensate water and automatically stops the supply of the condensate water if a leak of seawater is detected.

In a power plant, if a load rejection or turbine trip occurs, a turbine bypass valve opens and directly discharges steam from the steam generator to the condenser, preventing a pressure rise inside the steam generator. Hereinafter, this operation in which steam is directly discharged from the steam generator to the condenser is referred to as “turbine bypass operation.”

At the time of the turbine bypass operation, there is a risk of damaging the steam turbine due to a backflow of high-temperature steam from the condenser to the steam turbine. Thus, the power plant has a condenser attemperator spray (temperature adjustor) which cools the steam from the steam generator by using the condensate water pressurized by the condensate pump in order to prevent damage to the steam turbine due to the high-temperature steam.

According to conventional techniques, such as the technique disclosed in JP 2001-32701, if a leak of seawater is detected and the supply of condensate water is stopped, the water level in the steam generator falls and the steam turbine stops, carrying out the turbine bypass operation. In addition, the supply of condensate water to the condenser attemperator spray is stopped as well. Therefore, conventional techniques have a problem that there is a risk of damage to the steam turbine due to the turbine bypass operation if seawater leaks in the condenser.

An object of the invention is to provide a power plant that can prevent seawater from spreading in the power plant without damaging the steam turbine when the seawater leaks in the condenser.

### SUMMARY OF THE INVENTION

A power plant according to the invention includes a steam generator; a turbine driven by steam generated by the steam generator; a condenser which cools the steam discharged from the turbine to form condensate water by using seawater; a condensate water pipe which supplies the condensate water from the condenser to the steam generator; at least one seawater leak detection device which is included in the condensate water pipe and measures water quality of the condensate water to detect a leak of seawater in the condenser; an attemperator spray which connects to the condensate water pipe to be supplied with the condensate water from a connecting point where the attemperator spray connects to the condensate water pipe, and sprays the condensate water to the steam inside the condenser; and a pipe which diverges from the condensate water pipe and supplies the condensate water to the steam generator, wherein if the seawater leak detection device detects a leak of the seawater in the condenser, the power plant stops pouring the condensate water from the connecting point to the steam generator and stops pouring the condensate water to the pipe diverging from the condensate water pipe.

According to the invention, a power plant is provided that can prevent seawater from spreading in the power plant without damaging the steam turbine when the seawater leaks in the condenser.

### BRIEF DESCRIPTION OF THE DRAWINGS

FIG. 1 is a schematic view showing an outline of the configuration of a conventional power plant;

FIG. 2 is a schematic view showing an outline of the configuration of a power plant according to embodiment 1 of the invention;

FIG. 3 is a block diagram for describing a mechanism for detecting a leak of seawater in a condenser and actuating an interlock which stops the flow of condensate water to a nuclear reactor in the power plant according to the invention;

FIG. 4 is a schematic view showing an outline of the configuration of a power plant according to embodiment 3 of the invention;

FIG. 5 is a schematic view showing an outline of the configuration of a power plant according to embodiment 4 of the invention; and

FIG. 6 is a schematic view showing an outline of the configuration of the power plant shown in FIG. 2, in the case where the position of the diverging point is upstream of the connecting point.

### DETAILED DESCRIPTION OF THE PREFERRED EMBODIMENTS

In the description below, embodiments will be described in which the power plant is a nuclear power plant and the steam generator is a boiling water reactor. However, the invention can also be applied to other power plants, such as where the power plant is a nuclear power plant and the steam generator is a pressurized water steam generator, and where the power plant is a thermal power plant and the steam generator is a boiler. In the drawings referred to for the description below, the same elements are denoted by the same reference numbers and repeated explanation of these elements may be omitted in some cases.

### Embodiment 1

First, a conventional power plant will be described.

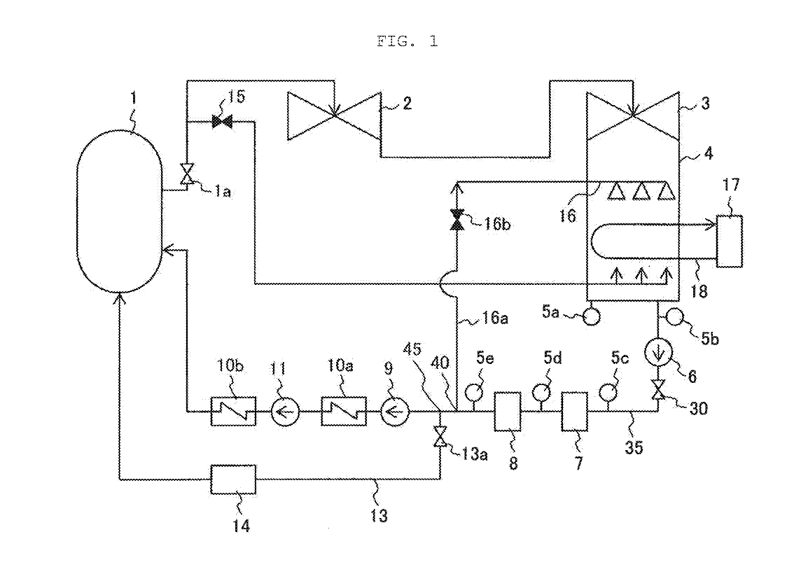

FIG. 1 is a schematic view showing an outline of the configuration of a conventional power plant. As shown in FIG. 1, the conventional power plant includes a nuclear reactor 1 which is a steam generator, a high-pressure steam turbine 2, a low-pressure steam turbine 3, and a condenser 4. The steam generated in the nuclear reactor 1 first drives the high-pressure steam turbine 2 and then drives the low-pressure steam turbine 3. The steam discharged from the low-pressure steam turbine 3 is cooled and condensed in the condenser 4, thus forming condensate water. The condensate water is supplied from the condenser 4 to the nuclear reactor 1.

The power plant also includes a main steam separation valve 1a, a circulating water system 17, a condenser thin tube 18, a condensate pump 6, a condensate booster pump 9, a feedwater pump 11, water supply heaters 10a, 10b, a condensate filter device 7, a condensate demineralization device 8, a control rod drive system 14, a spillover line 13, a spillover stop valve 13a, a turbine bypass valve 15, a condenser attemperator spray 16, seawater leak detection devices 5a to 5e, and a condenser outlet valve 30.

The main steam separation valve 1a is included in a pipe which discharges steam from the nuclear reactor 1. If supply of steam to the high-pressure steam turbine 2 is not to be carried out because of inspections or the like, the main steam separation valve 1a shuts off the supply of steam from the nuclear reactor 1 to the high-pressure steam turbine 2.

The circulating water system 17 and the condenser thin tube 18 form a system for supplying seawater (cooling water) for condensing steam to the condenser 4. The circulating water system 17 includes a pump to pump up seawater, and supplies the seawater to the condenser thin tube 18 arranged inside the condenser 4 and circulates the seawater in the condenser 4.

The condensate pump 6, the condensate booster pump 9 and the feedwater pump 11 are devices for supplying the condensate water inside the condenser 4 to the nuclear reactor 1. The condensate pump 6 pressurizes the condensate water discharged from the condenser 4. The condensate booster pump 9 further pressurizes the condensate water pressurized by the condensate pump 6. The feedwater pump 11 further pressurizes the condensate water pressurized by the condensate booster pump 9.

The feedwater heaters 10a, 10b are devices for raising the temperature of the condensate water supplied to the nuclear reactor 1.

The condensate filter device 7 and the condensate demineralization device 8 are devices for eliminating impurities from the condensate water and maintaining the water quality of the condensate water. The condensate filter device 7 filters out particle substances from the condensate water. The condensate demineralization device 8 eliminates ionic substances from the condensate water and thus demineralizes the condensate water.

The control rod drive system 14, the spillover line 13 and the spillover stop valve 13a form a system for driving control rods in the nuclear reactor 1. The spillover line 13 is a pipe diverging from a pipe 35 (condensate water pipe) which supplies the condensate water from the condenser 4 to the nuclear reactor 1. The diverging point 45 where the spillover line 13 diverges from the pipe 35 is provided downstream of the condensate demineralization device 8 in the flow of the condensate water from the condenser 4 to the nuclear reactor 1. The spillover line 13 is provided with the spillover stop valve 13a and supplies the condensate water to the control rod drive system 14. The condensate water supplied to the control rod drive system 14 is supplied to the nuclear reactor 1.

The turbine bypass valve 15 is a device which automatically opens and closes and discharges the main steam to the condenser 4 in order to control the pressure of the main steam generated from the nuclear reactor 1. The turbine bypass valve 15 is included in a pipe which discharges the steam from the nuclear reactor 1 to the condenser 4.

The condenser attemperator spray 16 is includes a pipe 16a through which the condensate water flows and a condenser attemperator spray valve 16b included in the pipe 16a, and cools the high-temperature steam discharged from the nuclear reactor 1 to the condenser 4 at the time of the turbine bypass operation (when the turbine bypass valve 15 opens). The condenser attemperator spray valve 16b automatically opens as the turbine bypass valve 15 opens. With the opening of the condenser attemperator spray valve 16b, the condenser attemperator spray 16 sprays the condensate water pressurized by the condensate pump 6 to the high-temperature steam flowing into the condenser 4 from the nuclear reactor 1 through the turbine bypass valve 15, cooling this steam, and preventing the low-pressure steam turbine 3 from being damaged by a backflow of the high-temperature steam from the condenser 4 to the low-pressure steam turbine 3. The pipe 16a through which the condensate water flows to the condenser attemperator spray 16 connects to the pipe 35 (condensate water pipe) supplying the condensate water from the condenser 4 to the nuclear reactor 1. The connecting point 40 where the pipe 16a connects to the pipe 35 is provided downstream of the condensate water filter device 7 and the condensate demineralization device 8 and upstream of the condensate booster pump 9 and the feedwater pump 11 in the flow of the condensate water through the condensate water pipe 35. In this way, the condenser attemperator spray 16 is supplied from the connecting point 40 with the condensate water from which impurities are eliminated and whose water quality is maintained.

The seawater leak detection devices 5a to 5e measure the water quality of the condensate water and detect a leak of seawater in the condenser 4. The seawater leak detection devices 5a to 5e measure, for example, the conductivity or the chlorine concentration of the condensate water as the water quality of the condensate water, and thereby detect a leak of seawater in the condenser 4. If the measured conductivity or chlorine concentration is above a predetermined reference value, it is determined that seawater has entered into the condensate water and that the seawater has leaked in the condenser 4.

In the embodiment shown in FIG. 1, the seawater leak detection device 5a is included in a hot well below the condenser 4. The seawater leak detection device 5b is included in a pipe connected to the outlet of the condenser 4. The seawater leak detection device 5c is included in a pipe connected to the inlet of the condensate filter device 7. The seawater leak detection device 5d is included in a pipe connected to the inlet of the condensate demineralization device 8. The seawater leak detection device 5e is included in a pipe connected to the outlet of the condensate demineralization device 8. The reference value for conductivity or chlorine concentration to determine that there is a leak of seawater in the condenser 4 is different between upstream and downstream of the condensate demineralization device 8. This is because the condensate water is demineralized by the condensate demineralization device 8, making the conductivity or chlorine concentration of the condensate water different between upstream and downstream of the condensate demineralization device 8.

The condenser outlet valve 30 is included in the pipe connected to the outlet of the condenser 4 and controls the outflow of the condensate water from the condenser 4. The condenser outlet valve 30 is included upstream of the connecting point 40 where the pipe 16a of the condenser attemperator spray 16, through which the condensate water flows, connects to the pipe 35 (condensate water pipe) supplying the condensate water from the condenser 4 to the nuclear reactor 1.

In the conventional power plant, if the seawater leak detection devices 5a to 5e detect a leak of seawater, the condenser outlet valve 30 is closed, the supply of the condensate water to the nuclear reactor 1 is stopped, and the water level in the nuclear reactor 1 falls in order to prevent the seawater from spreading in the power plant. In addition, the condensate pump 6, the condensate booster pump 9 and the feedwater pump 11 stop, and the spillover stop valve 13a is closed as well. As the water level in the nuclear reactor 1 falls and the steam turbines 2, 3 stop (i.e. as the turbines trip), the turbine bypass valve 15 automatically opens and the turbine bypass operation is carried out. At this time, since the condenser outlet valve 30 is closed, the supply of the condensate water to the condenser attemperator spray 16 is stopped as well. Therefore, there is a risk of damaging the low-pressure steam turbine 3 due to a backflow of the high-temperature steam from the nuclear reactor 1 from the condenser 4 to the low-pressure steam turbine 3.

In the power plant according to the invention, when seawater leaks into the condenser 4, the seawater can be prevented from spreading in the power plant without damaging the low-pressure steam turbine 3. Hereinafter, power plants according to embodiments of the invention will be described referring to the drawings. In the description below, the matters described referring to FIG. 1 is omitted to be described.

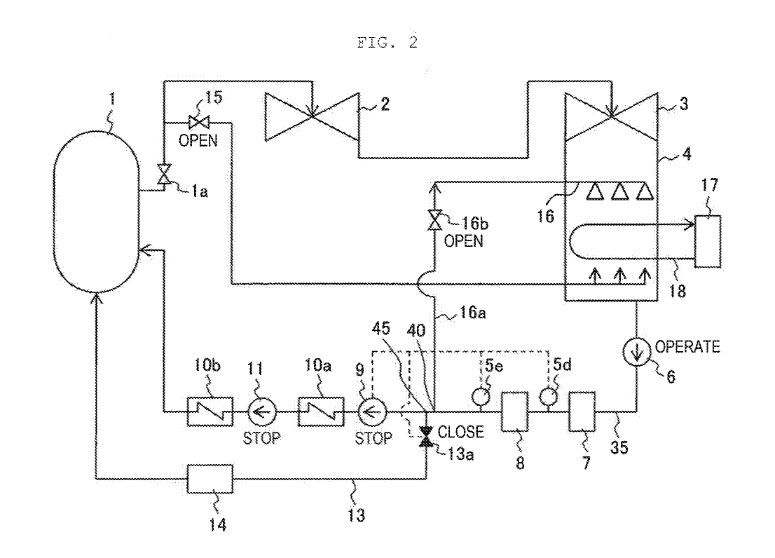

A power plant according to embodiment 1 of the invention will be described referring to FIG. 2. FIG. 2 is a schematic view showing an outline of the configuration of the power plant according to this embodiment. In the power plant according to this embodiment, a leak of seawater into the condenser 4 is detected using two seawater leak detection devices 5d, 5e. As described above, the seawater leak detection device 5d is included in the pipe connected to the inlet of the condensate demineralization device 8. The seawater leak detection device 5e is included in the pipe connected to the outlet of the condensate demineralization device 8.

If both of the seawater leak detection devices 5d, 5e detect a leak of seawater in the condenser 4, the seawater leak detection devices 5d, 5e actuate an interlock which stops pouring the condensate water to the nuclear reactor 1 from the connecting point 40 (the position where the pipe 16a of the condenser attemperator spray 16, through which the condensate water flows, connects to the condensate water pipe 35 supplying the condensate water from the condenser 4 to the nuclear reactor 1). Note that the condensate water flows to the connecting point 40 from the condenser 4.

That is, the seawater leak detection devices 5d, 5e transmit a signal to the condensate booster pump 9 to stop the condensate booster pump 9, thereby stopping the supply of the condensate water to the nuclear reactor 1 from the connecting point 40. Also, in order to stop the condensate water from flowing through the spillover line 13 and to stop the supply of the condensate water to the control rod drive system 14, the seawater leak detection devices 5d, 5e transmit a signal to the spillover stop valve 13a to close the spillover stop valve 13a. The pump (for example, the feedwater pump 11) downstream of the condensate booster pump 9 automatically stops as the interlock operates to stop the condensate booster pump 9. As such an operation of the interlock stops the supply of the condensate water to the nuclear reactor 1, causing the water level in the nuclear reactor 1 to fall and causing the steam turbines 2, 3 to stop (i.e. causing the turbines to trip), the turbine bypass valve 15 automatically opens and the turbine bypass operation is carried out.

Even if the interlock operates to stop the condensate booster pump 9 and the spillover stop valve 13a closes, the condensate pump 6 upstream of the connecting point 40 is in operation. That is, since the condensate pump 6 is in operation, it is possible to supply the condensate water from the condenser 4 to the condenser attemperator spray 16. In addition, as the turbine bypass valve 15 opens, the condenser attemperator spray valve 16b automatically opens. Therefore, even if high-temperature steam is supplied to the condenser 4 by the turbine bypass operation, the high-temperature steam can be cooled by the condenser attemperator spray 16 and a backflow of the high-temperature steam from the condenser 4 to the low-pressure steam turbine 3 can be prevented. Thus, the low-pressure steam turbine 3 can be protected and prevented from being damaged.

In this way, in the power plant according to this embodiment, if the seawater leak detection devices 5d, 5e detect a leak of seawater in the condenser 4, the pumps downstream of the connecting point 40 (for example, the condensate booster pump 9 and the feedwater pump 11) in the flow of the condensate water from the condenser 4 to the nuclear reactor 1 stop and the valves downstream of the connecting point 40 (for example, the spillover stop valve 13a) close, thereby automatically stopping the supply of the condensate water to the nuclear reactor 1. Thus, the seawater can be prevented from spreading in the power plant. Meanwhile, since the pump upstream of the connecting point 40 (for example, the condensate pump 6) remains in operation, the condensate water can be supplied to the condenser attemperator spray 16. Therefore, in the power plant according to this embodiment, even if seawater leaks in the condenser 4, the seawater can be prevented from spreading in the power plant without damaging the steam turbine (low-pressure steam turbine 3).

In this embodiment, the two seawater leak detection devices 5d, 5e are used, one being included in the pipe on the side of the inlet of the condensate demineralization device 8 and the other being included in the pipe on the side of the outlet of the condensate demineralization device 8. The power plant according to the invention can include only one seawater leak detection device. Moreover, the seawater leak detection device may be installed anywhere in the flow path (condensate water pipe 35) of the condensate water from the condenser 4 to the nuclear reactor 1. That is, the number of the seawater leak detection devices installed and the positions of the installation may be any as long as the seawater leak detection device can measure the water quality of the condensate water and detect a leak of seawater in the condenser 4.

In FIG. 2, the position of the diverging point 45 where the spillover line 13 diverges from the condensate water pipe 35 is provided downstream of the connecting point 40 where the pipe 16a connects to the condensate water pipe 35 in the flow of the condensate water from the condenser 4 to the nuclear reactor 1. However, the position of the diverging point 45 may be provided upstream of the connecting point 40 in the flow of the condensate water from the condenser 4 to the nuclear reactor 1.

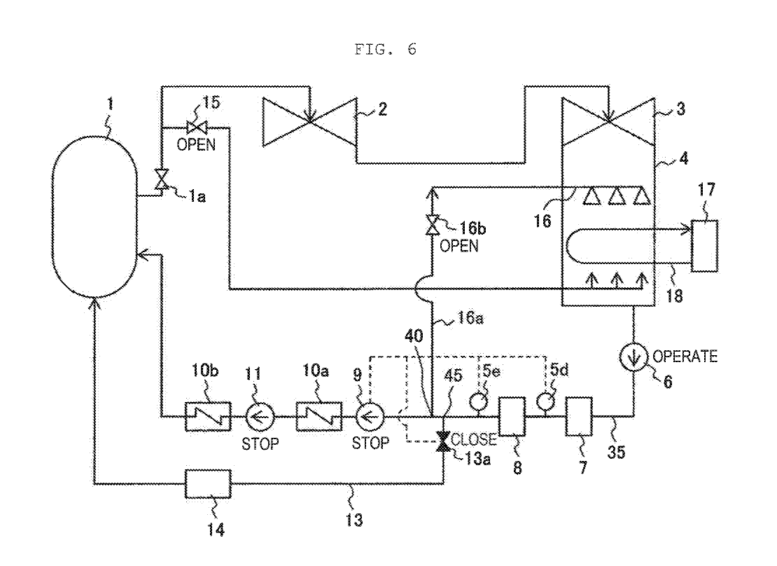

FIG. 6 is a schematic view showing an outline of the configuration of the power plant in the case where the position of the diverging point 45 is upstream of the connecting point 40 in the flow of the condensate water from the condenser 4 to the nuclear reactor 1. Even in the case where the diverging point 45 is located upstream of the connecting point 40, if the seawater leak detection devices 5d, 5e detect a leak of seawater in the condenser 4, the seawater leak detection devices 5d, 5e close the spillover stop valve 13a. Therefore, pouring of the condensate water to the nuclear reactor 1 from the diverging point 45 through the spillover line 13 can be stopped and the supply of the condensate water to the nuclear reactor 1 can be stopped.

### Embodiment 2

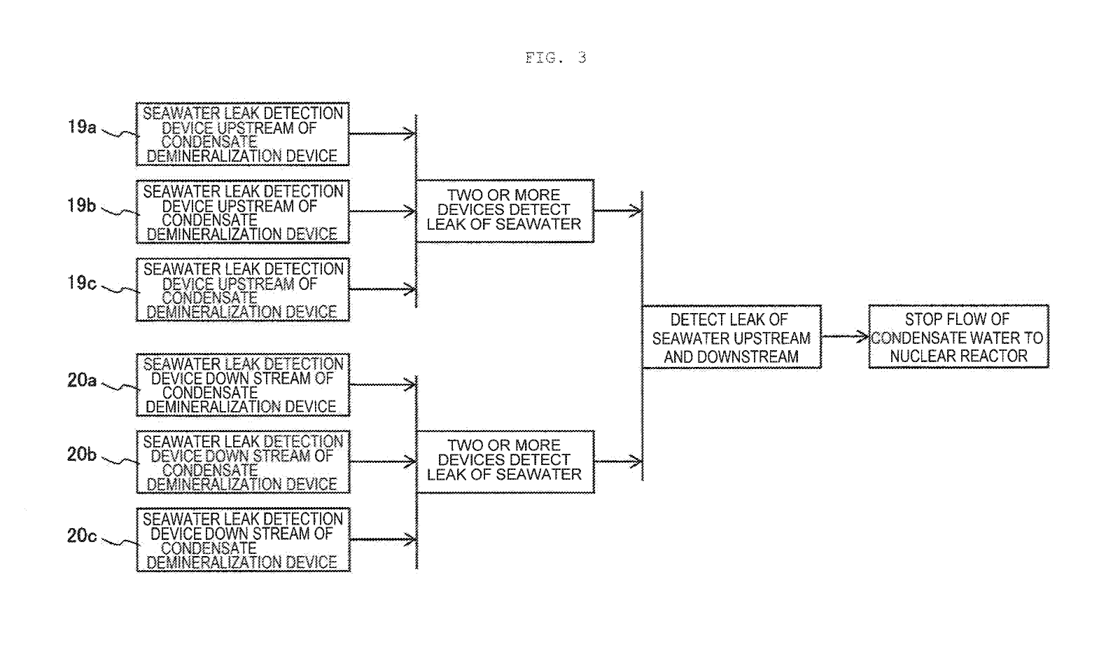

FIG. 3 is a block diagram for describing the mechanism for detecting a leak of seawater in the condenser 4 and actuating the interlock which stops the flow of the condensate water to the nuclear reactor 1 in the power plant according to the invention.

In the power plant, if the supply of water to the steam generator is stopped, the turbines stop and the power generation also stops. In the case of a nuclear power plant, stopping the supply of water to the nuclear reactor 1 as a steam generator may result in the loss of the entire water supply. Therefore, it is necessary to detect a leak of seawater in the condenser 4 as accurately as possible. In this embodiment, a configuration will be described for accurately detecting a leak of seawater in the condenser 4.

In this embodiment, three or more seawater leak detection devices are provided each upstream and downstream of the condensate demineralization device 8 in the flow of the condensate water from the condenser 4 to the nuclear reactor 1. Then, if more than half of the seawater leak detection devices upstream of the condensate demineralization device 8 detect a leak of seawater in the condenser 4 and more than half of the seawater leak detection devices downstream of the condensate demineralization device 8 detect a leak of seawater in the condenser 4, it is regarded that the seawater has leaked in the condenser 4, and the interlock is actuated which stops pouring the condensate water to the nuclear reactor 1. Providing the seawater leak detection devices upstream and downstream of the condensate demineralization device 8 enables measurement of the water quality (conductivity or chlorine concentration) of the condensate water before and after demineralization by the condensate demineralization device 8. Note that, as described in embodiment 1, the reference value for conductivity or chlorine concentration to determine that there is a leak of seawater in the condenser 4 differs between upstream and downstream of the condensate demineralization device 8.

FIG. 3 shows a case where three seawater leak detection devices 19a to 19c are provided upstream of the condensate demineralization device 8 and three seawater leak detection devices 20a to 20c are provided downstream of the condensate demineralization device 8, as an example. If more than half (two or more) of the three seawater leak detection devices 19a to 19c upstream of the condensate demineralization device 8 detect a leak of seawater in the condenser 4, the seawater leak detection devices upstream of the condensate demineralization device 8 determine that there is a leak of seawater in the condenser 4. Similarly, if more than half (two or more) of the three seawater leak detection devices 20a to 20c downstream of the condensate demineralization device 8 detect a leak of seawater in the condenser 4, the seawater leak detection devices downstream of the condensate demineralization device 8 determine that there is a leak of seawater in the condenser 4. Then, if the seawater leak detection devices both upstream and downstream of the condensate demineralization device 8 determine that there is a leak of seawater in the condenser 4, it is assumed that a leak of seawater in the condenser 4 is detected, and the interlock is actuated which stops pouring the condensate water to the nuclear reactor 1.

With actuating the interlock in this manner, even if one of the seawater leak detection devices 19a to 19c and 20a to 20c upstream and downstream of the condensate demineralization device 8 erroneously detects a leak of seawater, the interlock does not erroneously operate and the supply of the condensate water to the nuclear reactor 1 is not stopped. Therefore, a leak of seawater in the condenser 4 can be accurately detected and erroneous detection of a leak of seawater and erroneous operation of the interlock can be prevented.

For example, at the beginning of the startup of the power plant, as water with poor quality left in the water supply system flows into the condenser 4, the conductivity of the condensate water may rise transitionally. However, if the conductivity of the condensate water falls to or below the reference value through demineralization by the condensate demineralization device 8, a leak of seawater is not detected downstream of the condensate demineralization device 8 and erroneous operation can be prevented that the interlock is operated despite the absence of a leak of seawater.

The seawater leak detection devices 19a to 19c and 20a to 20c may be installed at any positions. For example, the seawater leak detection devices 19a to 19c upstream of the condensate demineralization device 8 can be installed at any positions of the seawater leak detection devices 5a to 5d shown in FIG. 1, and the seawater leak detection devices 20a to 20c downstream of the condensate demineralization device 8 can be installed at the position of the seawater leak detection device 5e shown in FIG. 1.

The seawater leak detection devices 20a to 20c provided downstream of the condensate demineralization device 8 detect the water quality of the condensate water after demineralization by the condensate demineralization device 8. Therefore, as the seawater leak detection devices 20a to 20c are installed downstream of the condensate demineralization device 8, the interlock can be prevented from operating when a small-scale leak of seawater occurs not exceeding the demineralization capability of the condensate demineralization device 8, namely, not requiring stopping the supply of the condensate water to the nuclear reactor 1.

### Embodiment 3

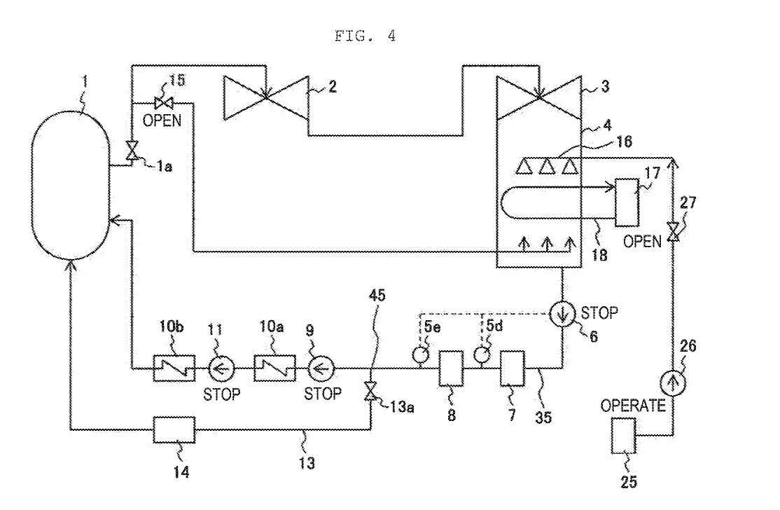

A power plant according to embodiment 3 of the invention will be described, referring to FIG. 4. FIG. 4 is a schematic view showing an outline of the configuration of the power plant according to this embodiment. The power plant according to this embodiment further includes a water tank 25 storing water and connecting to the condenser attemperator spray 16, a water tank pump 26 for supplying water from the water tank 25 to the condenser attemperator spray 16, and a control valve 27 which controls the supply of water from the water tank 25 to the condenser attemperator spray 16 in the power plant according to embodiment 1 (FIG. 2). The water tank pump 26 and the control valve 27 are included in a pipe included in the condenser attemperator spray 16 and connecting to the water tank 25.

In embodiment 1, the condensate water from the condenser 4 is used for the water supplied to the condenser attemperator spray 16 (water sprayed by the condenser attemperator spray 16). In this embodiment, the water from the water tank 25 is used for the water supplied to the condenser attemperator spray 16, instead of the condensate water. The water stored in the water tank 25 can be pure water, for example. A tank storing makeup water included in the power plant can be used as the water tank 25.

Also in this embodiment, as in embodiment 1, the seawater leak detection device 5d is included in the pipe connected to the inlet of the condensate demineralization device 8 and the seawater leak detection device 5e is included in the pipe connected to the outlet of the condensate demineralization device 8.

If both of the seawater leak detection devices 5d, 5e detect a leak of seawater in the condenser 4, the seawater leak detection devices 5d, 5e actuate the interlock which stops pouring the condensate water from the condenser 4 to the nuclear reactor 1.

Namely, the seawater leak detection devices 5d, 5e transmit a signal to the condensate pump 6 to stop the condensate pump 6, thereby stopping the supply of the condensate water from the condenser 4 to the nuclear reactor 1 and the control rod drive system 14. The pumps downstream of the condensate pump 6 (for example, the condensate booster pump 9 and the feedwater pump 11) automatically stop when the interlock operates to stop the condensate pump 6. When such an operation of the interlock stops the supply of the condensate water to the nuclear reactor 1, causing the water level in the nuclear reactor 1 to fall and causing the steam turbines 2, 3 to stop (i.e. causing the turbines to trip), the turbine bypass valve 15 automatically opens and the turbine bypass operation is carried out.

Moreover, as the turbine bypass valve 15 opens, a signal is transmitted from the turbine bypass valve 15 to the control valve 27 and the water tank pump 26, thus opening the control valve 27 and actuating the water tank pump 26. Consequently, water is supplied from the water tank 25 to the condenser attemperator spray 16, and the condenser attemperator spray 16 can spray the water to high-temperature steam flowing into the condenser 4. The supply of the water from the water tank 25 to the condenser attemperator spray 16 is stopped when the turbine bypass operation is stopped.

Even if the interlock operates to stop the condensate pump 6, the opening of the turbine bypass valve 15 causes the control valve 27 to open and actuates the water tank pump 26, thus supplying the water from the water tank 25 to the condenser attemperator spray 16. Thus, even if high-temperature steam is supplied to the condenser 4 by the turbine bypass operation, the high-temperature steam can be cooled by the condenser attemperator spray 16 and a backflow of the high-temperature steam from the condenser 4 to the low-pressure steam turbine 3 can be prevented. Therefore, the low-pressure steam turbine 3 can be protected and prevented from being damaged.

In this way, in the power plant according to this embodiment, if the seawater leak detection devices 5d, 5e detect a leak of seawater in the condenser 4, the pumps downstream of the condenser 4 (for example, the condensate pump 6, the condensate booster pump 9 and the feedwater pump 11) in the flow of the condensate water from the condenser 4 to the nuclear reactor 1 stop. Thus, the supply of the condensate water from the condenser 4 to the nuclear reactor 1 is automatically stopped and the seawater can be prevented from spreading in the power plant. Meanwhile, water can be supplied to the condenser attemperator spray 16 from the water tank 25. Therefore, in the power plant according to this embodiment, even if seawater leaks in the condenser 4, the seawater can be prevented from spreading in the power plant without damaging the steam turbine (low-pressure steam turbine 3).

The power plant according to this embodiment achieves the advantageous effect that the extent to which seawater spreads in the power plant can be minimized because the condensate water is prevented from being discharged from the condenser 4 when seawater leaks in the condenser 4, in addition to the achievement of the advantageous effects described in embodiment 1.

### Embodiment 4

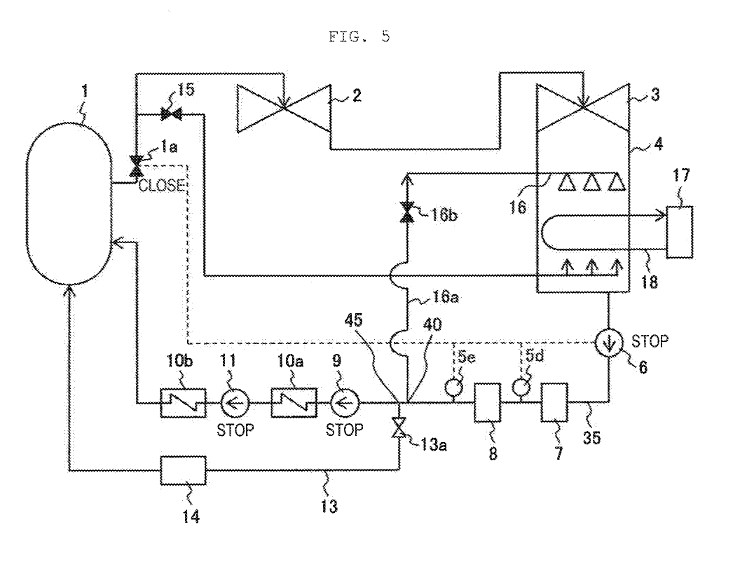

A power plant according to embodiment 4 of the invention will be described, referring to FIG. 5. FIG. 5 is a schematic view showing an outline of the configuration of the power plant according to this embodiment. The power plant according to this embodiment has a configuration similar to the power plant according to embodiment 1 (FIG. 2), but includes a valve and a pump different from those in the embodiment 1, which are controlled when the seawater leak detection devices 5d, 5e detect a leak of seawater in the condenser 4.

Also in this embodiment, as in embodiment 1, the seawater leak detection device 5d is included in the pipe connected to the inlet of the condensate demineralization device 8 and the seawater leak detection device 5e is included in the pipe connected to the outlet of the condensate demineralization device 8.

If both of the seawater leak detection devices 5d, 5e detect a leak of seawater in the condenser 4, the seawater leak detection devices 5d, 5e actuate the interlock which stops pouring the condensate water from the condenser 4 to the nuclear reactor 1.

That is, the seawater leak detection devices 5d, 5e transmit a signal to the condensate pump 6 to stop the condensate pump 6, thereby stopping the supply of the condensate water from the condenser 4 to the nuclear reactor 1 and the control rod drive system 14. The pumps downstream of the condensate pump 6 (for example, the condensate booster pump 9 and the feedwater pump 11) automatically stop as the interlock operates to stop the condensate pump 6. Moreover, the seawater leak detection devices 5d, 5e transmit a signal to the main steam separation valve 1a to close the main steam separation valve 1a. When such an operation of the interlock stops the supply of the condensate water to the nuclear reactor 1, causing the water level in the nuclear reactor 1 to fall and causing the steam turbines 2, 3 to stop (i.e. causing the turbines to trip), the turbine bypass valve 15 automatically opens. However, since the main steam separation valve 1a is closed, high-temperature steam is not supplied from the nuclear reactor 1 to the condenser 4 and damage to the low-pressure steam turbine 3 can be prevented.

Although the pressure inside the nuclear reactor 1 rises due to high-temperature steam, the pressure inside the nuclear reactor 1 can be lowered by a safety device included in the nuclear reactor 1.

In this way, in the power plant according to this embodiment, if the seawater leak detection devices 5d, 5e detect a leak of seawater in the condenser 4, the pumps downstream of the condenser 4 (for example, the condensate pump 6, the condensate booster pump 9 and the feedwater pump 11) in the flow of the condensate water from the condenser 4 to the nuclear reactor 1 stop. Thus, the supply of the condensate water from the condenser 4 to the nuclear reactor 1 is automatically stopped and the seawater can be prevented from spreading in the power plant. Meanwhile, the supply of steam from the nuclear reactor 1 to the condenser 4 is stopped by closing the main steam separation valve 1a. Therefore, in the power plant according to this embodiment, even if seawater leaks in the condenser 4, the seawater can be prevented from spreading in the power plant without damaging the steam turbine (low-pressure steam turbine 3).

The power plant according to this embodiment achieves the advantageous effect that the extent to which seawater spreads in the power plant can be minimized because the condensate water is prevented from being discharged from the condenser 4 when seawater leaks in the condenser 4, in addition to the achievement of the advantageous effects described in embodiment 1. Further, the power plant has the advantageous effect that the water tank 25, the water tank pump 26 and the control valve 27 described in the embodiment 3 are not needed.

It should be noted that the invention is not limited to the above embodiments and includes various modifications. For example, the above embodiments are described in detail in order to make the invention easy to understand. The invention is not necessarily limited to an embodiment that has all the configurations described above. Also, a part of the configuration in one embodiment can be replaced with the configuration in another embodiment. Moreover, the configuration in one embodiment can be added to the configuration in another embodiment. Also, with respect to a part of the configuration in each embodiment, addition, deletion and replacement can be made with the configuration in another embodiment.

### EXPLANATION OF REFERENCE CHARACTERS

1: nuclear reactor
1a: main steam separation valve
2: high-pressure steam turbine
3: low-pressure steam turbine
4: condenser
5a to 5e: seawater leak detection devices
6: condensate pump
7: condensate filter device
8: condensate demineralization device
9: condensate booster pump
10a, 10b: feedwater heaters
11: feedwater pump
13: spillover line
13a: spillover stop valve
14: control rod drive system
15: turbine bypass valve
16: condenser attemperator spray
16a: pipe of condenser attemperator spray, through which condensate water flows
16b: condenser attemperator spray valve
17: circulating water system
18: condenser thin tube
19a to 19c: seawater leak detection devices
20a to 20c: seawater leak detection devices
25: water tank
26: water tank pump
27: control valve
30: condenser outlet valve
35: pipe supplying condensate water from condenser to nuclear reactor (condensate water pipe)
40: connecting point
45: diverging point

What is claimed is:

1. A power plant comprising:
a steam generator;
a turbine driven by steam generated by the steam generator;
a condenser which cools the steam discharged from the turbine to form condensate water by using seawater;
a condensate water pipe which supplies the condensate water from the condenser to the steam generator;
at least one seawater leak detection device which is included in the condensate water pipe and measures water quality of the condensate water to detect a leak of seawater in the condenser;
an attemperator spray which connects to the condensate water pipe to be supplied with the condensate water from a connecting point where the attemperator spray connects to the condensate water pipe, and sprays the condensate water to the steam inside the condenser; and
a pipe which diverges from the condensate water pipe and supplies the condensate water to the steam generator,
wherein if the seawater leak detection device detects a leak of the seawater in the condenser, the power plant stops pouring the condensate water from the connecting point to the steam generator and stops pouring the condensate water to the pipe diverging from the condensate water pipe.

2. The power plant according to claim 1, further comprising:
a pump included in the condensate water pipe, downstream of the connecting point in a flow of the condensate water in the condensate water pipe; and
a valve included in the pipe diverging from the condensate water pipe,
wherein if the seawater leak detection device detects a leak of the seawater in the condenser, the pump stops and the valve closes.

3. A power plant comprising:
a steam generator;
a turbine driven by steam generated by the steam generator;
a condenser which cools the steam discharged from the turbine to form condensate water by using seawater;
a condensate water pipe which supplies the condensate water from the condenser to the steam generator;
at least one seawater leak detection device which is included in the condensate water pipe and measures water quality of the condensate water to detect a leak of seawater in the condenser;
a water tank for storing water; and
an attemperator spray which includes a pipe, connects to the water tank with the pipe, and sprays the water to the steam inside the condenser,
wherein if the seawater leak detection device detects a leak of seawater in the condenser, the power plant stops pouring the condensate water from the condenser to the steam generator and supplies the water from the water tank to the attemperator spray.

4. The power plant according to claim 3, further comprising:
a pump included in the condensate water pipe; and
a pump included in the pipe of the attemperator spray,
wherein if the seawater leak detection device detects a leak of the seawater in the condenser, the pump included in the condensate water pipe stops and the pump included in the pipe of the attemperator spray operates.

5. A power plant comprising:
a steam generator;
a turbine driven by steam generated by the steam generator;
a condenser which cools the steam discharged from the turbine to form condensate water by using seawater;
a condensate water pipe which supplies the condensate water from the condenser to the steam generator;
at least one seawater leak detection device which is included in the condensate water pipe and measures water quality of the condensate water to detect a leak of seawater in the condenser; and
a main steam separation valve included in a pipe which discharges the steam from the steam generator,
wherein if the seawater leak detection device detects a leak of the seawater in the condenser, the power plant stops pouring the condensate water from the condenser to the steam generator and closes the main steam separation valve.

6. The power plant according to claim 5, further comprising:
a pump included in the condensate water pipe,
wherein if the seawater leak detection device detects a leak of the seawater in the condenser, the pump stops.

7. The power plant according to claim 1, further comprising:
a demineralization device which is included in the condensate water pipe and demineralizes the condensate water,
wherein the at least one seawater leak detection device comprises a plurality of seawater leak detection devices,
wherein the seawater leak detection devices are included upstream and downstream of the demineralization device in a flow of the condensate water in the condensate water pipe, and
wherein if both of the seawater leak detection devices included upstream and downstream detect a leak of the seawater in the condenser, the power plant stops pouring the condensate water from the connecting point to the steam generator and stops pouring the condensate water to the pipe diverging from the condensate water pipe.

8. The power plant according to claim 2, further comprising:
a demineralization device which is included in the condensate water pipe and demineralizes the condensate water,
wherein the at least one seawater leak detection device comprises a plurality of seawater leak detection devices,
wherein the seawater leak detection devices are included upstream and downstream of the demineralization device in a flow of the condensate water in the condensate water pipe, and
wherein if both of the seawater leak detection devices included upstream and downstream detect a leak of the seawater in the condenser, the power plant stops pouring the condensate water from the connecting point to the steam generator and stops pouring the condensate water to the pipe diverging from the condensate water pipe.

9. The power plant according to claim 3, further comprising:
a demineralization device which is included in the condensate water pipe and demineralizes the condensate water,
wherein the at least one seawater leak detection device comprises a plurality of seawater leak detection devices,
wherein the seawater leak detection devices are included upstream and downstream of the demineralization device in a flow of the condensate water in the condensate water pipe, and
wherein if both of the seawater leak detection devices included upstream and downstream detect a leak of the seawater in the condenser, the power plant stops pouring the condensate water from the condenser to the steam generator and supplies the water from the water tank to the attemperator spray.

10. The power plant according to claim 4, further comprising:
a demineralization device which is included in the condensate water pipe and demineralizes the condensate water,
wherein the at least one seawater leak detection device comprises a plurality of seawater leak detection devices,
wherein the seawater leak detection devices are included upstream and downstream of the demineralization device in a flow of the condensate water in the condensate water pipe, and
wherein if both of the seawater leak detection devices included upstream and downstream detect a leak of the seawater in the condenser, the power plant stops pouring the condensate water from the condenser to the steam generator and supplies the water from the water tank to the attemperator spray.

11. The power plant according to claim 5, further comprising:
a demineralization device which is included in the condensate water pipe and demineralizes the condensate water,
wherein the at least one seawater leak detection device comprises a plurality of seawater leak detection devices,
wherein the seawater leak detection devices are included upstream and downstream of the demineralization device in a flow of the condensate water in the condensate water pipe, and
wherein if both of the seawater leak detection devices included upstream and downstream detect a leak of the seawater in the condenser, the power plant stops pouring the condensate water from the condenser to the steam generator and closes the main steam separation valve.

12. The power plant according to claim 6, further comprising:
a demineralization device which is included in the condensate water pipe and demineralizes the condensate water,
wherein the at least one seawater leak detection device comprises a plurality of seawater leak detection devices,
wherein the seawater leak detection devices are included upstream and downstream of the demineralization device in a flow of the condensate water in the condensate water pipe, and
wherein if both of the seawater leak detection devices included upstream and downstream detect a leak of the seawater in the condenser, the power plant stops pouring the condensate water from the condenser to the steam generator and closes the main steam separation valve.
